(19) United States
(12) Patent Application Publication
(10) Pub. No.: US 2026/0204290 A1
(43) Pub. Date: Jul. 16, 2026

(54) EFFECT VIDEO GENERATION METHOD AND APPARATUS, ELECTRONIC DEVICE, AND STORAGE MEDIUM

(71) Applicant: Beijing Zitiao Network Technology Co., Ltd., Beijing (CN)

(72) Inventors: Lei XU, Beijing (CN); Pengqi TU, Beijing (CN); Yuan ZHU, Beijing (CN); Shuang ZHANG, Beijing (CN)

(21) Appl. No.: 19/444,074

(22) Filed: Jan. 8, 2026

(30) Foreign Application Priority Data
Jan. 14, 2025 (CN) 202510059290.5

(51) Int. Cl. G11B 27/031; G06F 3/0482; G06F 3/0484

(52) U.S. Cl. CPC G11B 27/031; G06F 3/0482; G06F 3/0484

(57) ABSTRACT

Embodiments of the present disclosure provide an effect video generation method and apparatus, an electronic device, and a storage medium. The method includes: obtaining a target image, where the target image is used to present at least two target visual objects; displaying at least one action template in response to a first operation, where the action template is configured to represent an interactive behavior between two or more visual objects; and determining a target action template in response to a second operation, and generating an effect video based on the target action template and the target image, where the effect video is used to present a process in which the at least two target visual objects perform a target interactive behavior represented by the target action template. After the target image is obtained, the action template is presented through a corresponding user operation, and the effect video is generated for the target image based on the selected target action template.

### CROSS REFERENCE TO RELATED APPLICATIONS

This application is based on and claims priority of CN application with application No. 202510059290.5 filed on Jan. 14, 2025, the entire disclosure of which is incorporated herein by reference.

### TECHNICAL FIELD

Embodiments of the present disclosure relate to the field of artificial intelligence technologies, and in particular, to an effect video generation method and apparatus, an electronic device, and a storage medium.

### BACKGROUND

Currently, content continuation and extension for static images can be implemented based on artificial intelligence (AI) technologies, to generate corresponding videos, which is known as an image-to-video technology. This technology has greatly improved video material generation efficiency and content richness for users during video creation.

### SUMMARY

Embodiments of the present disclosure provide an effect video generation method and apparatus, an electronic device, and a storage medium, to overcome low interaction efficiency and high operational difficulty during generation of a video with multi-object interaction content.

According to a first aspect, an embodiment of the present disclosure provides an effect video generation method. The method includes:
obtaining a target image, where the target image is used to present at least two target visual objects; displaying at least one action template in response to a first operation, where the action template is configured to represent an interactive behavior between two or more visual objects; and determining a target action template in response to a second operation, and generating an effect video based on the target action template and the target image, where the effect video is used to present a process in which the at least two target visual objects perform a target interactive behavior represented by the target action template.

According to a second aspect, an embodiment of the present disclosure provides an effect video generation apparatus. The apparatus includes:
an obtaining module configured to obtain a target image, where the target image is used to present at least two target visual objects;
an interaction module configured to display at least one action template in response to a first operation, where the action template is configured to represent an interactive behavior between two or more visual objects; and determine a target action template in response to a second operation; and
a generation module configured to generate an effect video based on the target action template and the target image, where the effect video is used to present a process in which the at least two target visual objects perform a target interactive behavior represented by the target action template.

According to a third aspect, an embodiment of the present disclosure provides an electronic device. The electronic device includes: a processor and a memory, where
the memory has computer-executable instructions stored therein; and
the processor executes the computer-executable instructions stored in the memory, to cause the at least one processor to perform the effect video generation method according to the first aspect and various possible designs of the first aspect.

According to a fourth aspect, an embodiment of the present disclosure provides a computer-readable storage medium, having computer-executable instructions stored therein that, when executed by a processor, cause the effect video generation method according to the first aspect and various possible designs of the first aspect to be implemented.

According to a fifth aspect, an embodiment of the present disclosure provides a computer program product including a computer program. When the computer program is executed by a processor, the effect video generation method according to the first aspect and various possible designs of the first aspect is implemented.

### BRIEF DESCRIPTION OF THE DRAWINGS

In order to describe the technical solutions in embodiments of the present disclosure or in the related art more clearly, the accompanying drawings for describing the embodiments or the related art are briefly described below. Apparently, the accompanying drawings in the following description are some embodiments of the present disclosure, and those of ordinary skill in the art may still derive other accompanying drawings from these accompanying drawings without creative efforts.

FIG. 1 is a diagram of an application scenario of an effect video generation method according to an embodiment of the present disclosure;

FIG. 2 is a first schematic flowchart of an effect video generation method according to an embodiment of the present disclosure;

FIG. 3 is a flowchart of a specific implementation of step S101 in the embodiment shown in FIG. 2;

FIG. 4 is a schematic diagram of a process of displaying a template page according to an embodiment of the present disclosure;

FIG. 5 is a flowchart of a specific implementation of step S1011 in the embodiment shown in FIG. 3;

FIG. 6 is a second schematic flowchart of an effect video generation method according to an embodiment of the present disclosure;

FIG. 7 is a schematic diagram of a process of generating an effect video according to an embodiment of the present disclosure;

FIG. 8 is a flowchart of a specific implementation of step S201A in the embodiment shown in FIG. 6;

FIG. 9 is a flowchart of a specific implementation of step S209 in the embodiment shown in FIG. 6;

FIG. 10 is a schematic diagram of a process of generating mapping information according to an embodiment of the present disclosure;

FIG. 11 is a structural block diagram of an effect video generation apparatus according to an embodiment of the present disclosure;

FIG. 12 is a schematic structural diagram of an electronic device according to an embodiment of the present disclosure; and

FIG. 13 is a schematic structural diagram of hardware of an electronic device according to an embodiment of the present disclosure.

### DETAILED DESCRIPTION

In order to make the objectives, technical solutions, and advantages of embodiments of the present disclosure clearer, the technical solutions in the embodiments of the present disclosure are described clearly and completely below with reference to the accompanying drawings in the embodiments of the present disclosure. Apparently, the embodiments described are some rather than all of the embodiments of the present disclosure. All other embodiments obtained by those of ordinary skill in the art based on the embodiments of the present disclosure without any creative efforts shall fall within the scope of protection of the present disclosure.

It should be noted that user information (including but not limited to device information, personal information, and the like of a user) and data (including but not limited to data for analysis, stored data, displayed data, and the like) involved in the present disclosure are information and data for which an authorization is obtained from the user or a full authorization is obtained from each party, and the collection, use, and processing of relevant data need to comply with relevant laws, regulations, and standards of relevant countries and regions, for which corresponding operation entries are provided for the user to choose to authorize or deny.

An application scenario of the embodiments of the present disclosure is explained below.

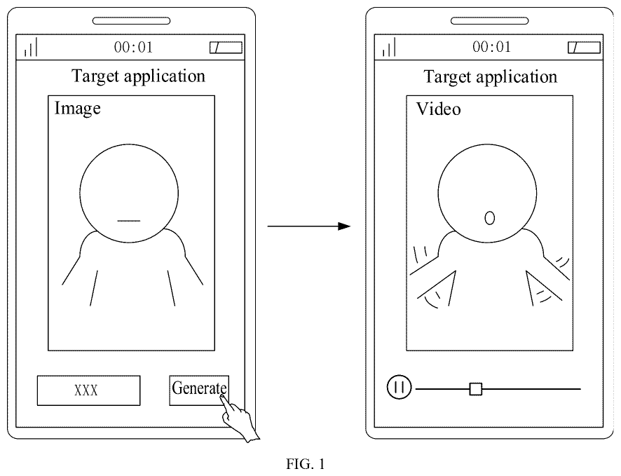

FIG. 1 is a diagram of an application scenario of an effect video generation method according to an embodiment of the present disclosure. The effect video generation method according to this embodiment of the present disclosure may be applied to an application (APP) having an effect video generation function, for example, a video editing application. More specifically, the method may be applied to an AI model-based image-to-video application scenario. An execution entity of this embodiment may be a terminal device that runs the above-mentioned application having the effect video generation function, may be a server on which a server end corresponding to the above-mentioned application is deployed, or may be another electronic device that has a similar function. When the execution entity is the terminal device, the terminal device performs the method according to this embodiment by running the above-mentioned application. When the execution entity is the server, the server end of the above-mentioned application having the effect video generation function may be partially or fully run on the server, and the method according to this embodiment is performed at the server end; the terminal device runs a client end of the application; and the server communicates with the terminal device via the server end and the client end, so that the terminal device can obtain a result of performing the method according to this embodiment, and display the result as needed.

In some embodiments, the terminal device or the server may implement the effect video generation method according to this embodiment of the present disclosure by running various computer-executable instructions or a computer program. For example, the computer-executable instructions may be program-level commands, machine instructions, or software instructions. The computer program may be a native program or a software module in an operating system. It may be a local application, that is, a program that needs to be installed in the operating system to run, or may be an applet embedded into any APP, that is, a program that runs in a browser-based environment. In conclusion, the above-mentioned computer-executable instructions may be instructions in any form, and the above-mentioned computer program may be an application, module, or plug-in in any form. Specific implementations may be configured as needed. Further, in implementing the effect video generation method according to this embodiment of the present disclosure, the terminal device may perform the method by running computer-executable instructions or a computer program locally provided, or perform the method by invoking computer-executable instructions or a computer program deployed on an external server. In some embodiments, the server may be a standalone physical server, a server cluster or distributed system including a plurality of physical servers, or a cloud server providing a cloud service, cloud storage, cloud communication, a cloud database, cloud computing, a cloud function, a network service, a middleware service, a domain name service, a security service, a content delivery network (CDN), and a basic cloud computing service such as big data and an artificial intelligence platform. The cloud service may be an interactive processing service that is called by the terminal device.

Referring to FIG. 1, the terminal device is used as an example. A target application having an effect video generation function is run on the terminal device. An image input by a user (e.g., a selfie uploaded by the user) is loaded through the target application, and then a video generation model deployed in a cloud or locally is invoked in response to a trigger operation of the user (e.g., tapping a “Generate” button), to convert the static image to a corresponding dynamic video. In this process, the target application typically controls content of the generated video based on a descriptive sentence (shown as XXX in the figure) input by the user, thereby generating the dynamic video that meets user preferences and requirements.

Currently, in a task of generating an AI video with multi-object interaction content, for example, in an image-to-video application scenario of generating an effect video with two or more persons hugging or dancing, the complexity of the video content and the process necessitates complex prompts to depict behavior characteristics in interaction between a plurality of persons. This results in complex operation steps, high usability barriers, and other problems, which affects human-computer interaction efficiency.

In the related art, during generation of a video with multi-object interaction content based on an AI model, a user typically needs to input complex corresponding prompts for describing video content, such that the AI model can output video content that meets user requirements.

However, in the related art, solutions of generating videos with multi-object interaction content using prompts suffer from low interaction efficiency and high operational difficulty.

An embodiment of the present disclosure provides an effect video generation method to address the above-mentioned problems.

The embodiments provide the effect video generation method and apparatus, the electronic device, and the storage medium. The method includes: obtaining the target image, where the target image is used to display the at least two target visual objects; displaying the at least one action template in response to the first operation, where the action template is configured to represent the interactive behavior between the two or more visual objects; and determining the target action template in response to the second operation, and generating the effect video based on the target action template and the target image, where the effect video is used to present the process in which the at least two target visual objects perform the target interactive behavior represented by the target action template. After the target image is obtained, the action template is presented through a corresponding user operation, and the effect video is generated for the target image based on the selected target action template. In this way, the generated effect video can present a process in which a plurality of target visual objects in the target image perform the target interactive behavior represented by the target action template, and in this process, a user does not need to input a complex prompt. Therefore, efficiency of interaction in a video generation process is effectively improved, operational difficulty is reduced for the user, and the user experience is improved.

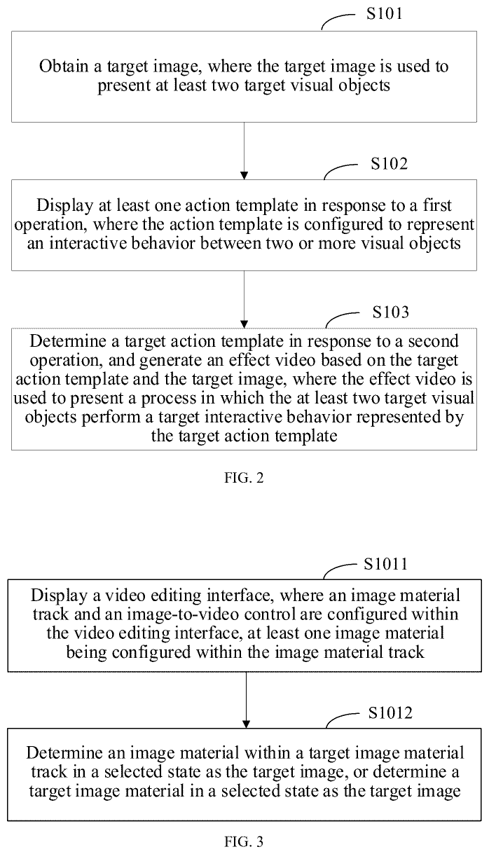

Referring to FIG. 2, FIG. 2 is a first schematic flowchart of an effect video generation method according to an embodiment of the present disclosure. The method according to this embodiment may be applied to a terminal device. The effect video generation method includes the following steps.
Step S101: Obtain a target image, where the target image is used to present at least two target visual objects.
Step S102: Display at least one action template in response to a first operation, where the action template is configured to represent an interactive behavior between two or more visual objects.
Step S103: Determine a target action template in response to a second operation, and generate an effect video based on the target action template and the target image, where the effect video is used to present a process in which the at least two target visual objects perform a target interactive behavior represented by the target action template.

For example, referring to the schematic diagram of the application scenario shown in FIG. 1, the effect video generation method provided in this embodiment is described with the terminal device as the execution entity. First, the terminal device displays an interactive interface, such as a video editing interface provided with a video editing track, by running the above-mentioned application having the effect video generation function. Through an operation on the video editing interface, a user loads at least one static image into the target application from the terminal device or from the cloud, so that the terminal device obtains the target image, where the target image is the one or more static images. Image content of the static image includes at least one visual object. The visual object is, for example, a photographed subject such as a person or an animal in the image. A portrait image is used as an example, and a target object in the portrait image is a “person” in the portrait image. When the target image is a static image, the static image includes at least two target objects, for example, a plurality of “persons” in the portrait image. When the target image includes at least two static images, each static image may include one or more target objects. For example, the target image includes two portrait images, and each portrait image includes one “person”. In this way, the target image obtained by the terminal device can present the at least two target visual objects.

Further, through an operation on the interactive interface, the user controls the terminal device to display the action template. Specifically, upon receiving the first operation from the user, the terminal device displays a plurality of action templates for representation. The action template may be displayed within a template page or a template window in the form of a card. The action template may represent an interactive behavior between two or more visual objects by a template cover, a template name, or other explanatory information, thereby achieving the purpose of usage guidance. Then, the user further performs the second operation on the template page or the template window to determine the target action template from one or more action templates. Next, the terminal device provides a content guidance for a video generation model based on the target interactive behavior, e.g., hugs, kisses, or handshakes of the plurality of persons, described by the target action template, so as to control an image-to-video process. Finally, an effect video with the above-mentioned interactive behavior characteristics is generated from the target image.

In a possible implementation, as shown in FIG. 3, a specific manner of step S101 includes the following steps.
Step S1011: Display the video editing interface, where an image material track and an image-to-video control are configured within the video editing interface, at least one image material being configured within the image material track.
Step S1012: Determine an image material within a target image material track in a selected state as the target image, or determine a target image material in a selected state as the target image.

For example, the interactive interface of the above-mentioned target application is the video editing interface. The image material track and the image-to-video control are configured within the video editing interface, the at least one image material being configured within the image material track. In a possible implementation, the user may directly select any image material as the target image. In another possible implementation, for the above-mentioned video editing interface, the user selects a plurality of image materials from different material tracks as the target image by performing a selection operation. In yet another possible implementation, for the above-mentioned video editing interface, the user selects an image material track, i.e., the target image material track, by performing a selection operation, and then determines all image materials within the target image material track as the target image, that is, selects the target image on a track dimension.

In this implementation, accordingly, a specific implementation of step S102 is: displaying the template page in response to the first operation on the image-to-video control, where the template page is configured to display the at least one action template.

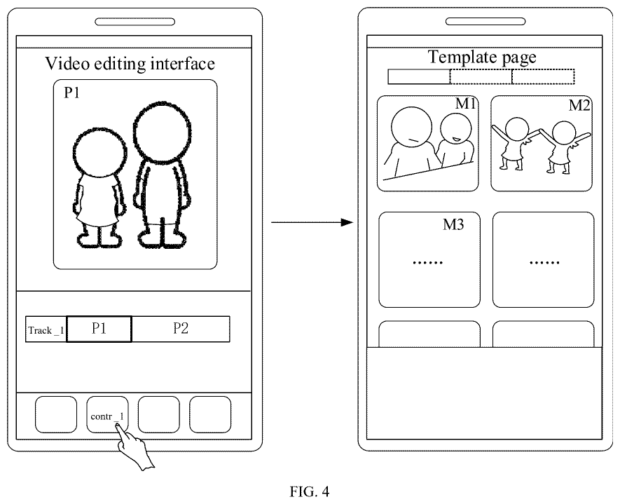

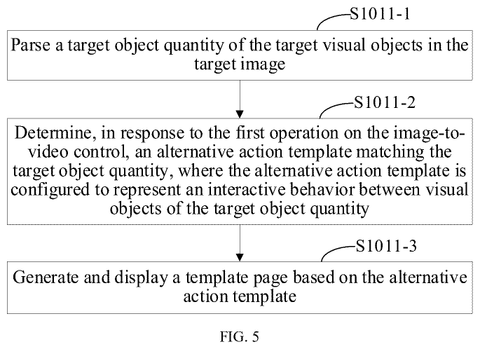

FIG. 4 is a schematic diagram of a process of displaying a template page according to an embodiment of the present disclosure. As shown in FIG. 4, an image material track Track_1 is displayed within the video editing interface, and image materials P1 and P2 are configured within the image material track Track_1. On this basis, when the image material P1 is selected, the image material P1 is used as the target image, and navigation to the template page is triggered in response to the first operation on an image-to-video control contr_1. Action templates representing different interactive behaviors are displayed within the template page, such as M1, M2, and M3 shown in the figure. Different action templates have template covers, and the template covers may indicate the interactive behaviors represented by the action templates.

Further, in a possible implementation, the action templates displayed within the template page are pre-configured, that is, fixed action templates. They may be loaded in advance by using configuration information, so that each action template can be quickly displayed after the template page is triggered. In another possible implementation, the action template displayed within the template page is loaded dynamically. As shown in FIG. 5, a specific implementation of step S1011 includes the following steps.
Step S1011-1: Parse a target object quantity of the target visual objects in the target image.
Step S1011-2: Determine, in response to the first operation on the image-to-video control, an alternative action template matching the target object quantity, where the alternative action template is configured to represent an interactive behavior between visual objects of the target object quantity.
Step S1011-3: Generate and display the template page based on the alternative action template.

For example, after the target image is obtained, the target object quantity of the target visual objects in the target image is determined by parsing content of the target image. Then, the alternative action template matching the target object quantity is dynamically displayed based on the target object quantity of the target visual objects in the target image. For example, if the target object quantity of the target visual objects in the target image is 3, an interactive behavior represented by the alternative action template matching the target object quantity is, for example, three-person hugging or three-person hand-holding. In other words, the alternative action template is configured to represent the interactive behavior between the visual objects of the target object quantity. Then, the template page is generated and displayed with the above-mentioned alternative action template as content. In this way, the action template within the template page can match the target image selected by the user, and during subsequent generation of the effect video, as a content template with the same visual object quantity, can achieve better content guidance effects and improve the realism of the effect video.

Further, in a possible implementation, the target image includes at least a first image and a second image. For the step of parsing the target object quantity of the target visual objects in the target image, when the target image includes at least two images or more, each image needs to be parsed to obtain an object quantity of target visual objects in each image, and then the object quantities of target visual objects in the images are accumulated to obtain the target object quantity. This improves the accuracy of the target object quantity, thereby improving a matching degree between the alternative action template within the template page and the target image.

In this embodiment, the target image is obtained, where the target image is used to present the at least two target visual objects. The at least one action template is displayed in response to the first operation, where the action template is configured to represent the interactive behavior between the two or more visual objects. The target action template is determined in response to the second operation, and the effect video is generated based on the target action template and the target image, where the effect video is used to present the process in which the at least two target visual objects perform the target interactive behavior represented by the target action template. After the target image is obtained, the action template is presented through a corresponding user operation, and the effect video is generated for the target image based on the selected target action template. In this way, the generated effect video can present a process in which a plurality of target visual objects in the target image perform the target interactive behavior represented by the target action template, and in this process, the user does not need to input a complex prompt. Therefore, efficiency of interaction in a video generation process is effectively improved, operational difficulty is reduced for the user, and the user experience is improved.

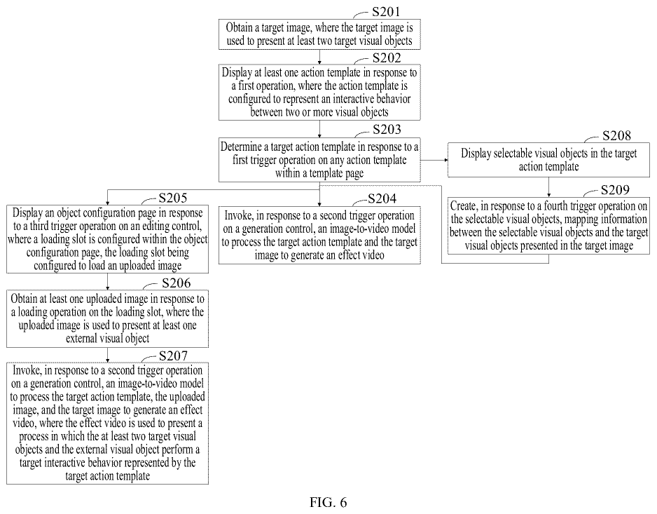

Referring to FIG. 6, FIG. 6 is a second schematic flowchart of an effect video generation method according to an embodiment of the present disclosure. This embodiment further refines step S103 on the basis of the embodiment shown in FIG. 2. The action template is displayed within the template page, a generation control is configured within the template page, and the second operation includes a first trigger operation and a second trigger operation. The effect video generation method includes the following steps.
Step S201: Obtain a target image, where the target image is used to present at least two target visual objects.
Step S202: Display at least one action template in response to a first operation, where the action template is configured to represent an interactive behavior between two or more visual objects.
Step S203: Determine a target action template in response to a first trigger operation on any action template within a template page.
Step S204: Invoke, in response to a second trigger operation on a generation control, an image-to-video model to process the target action template and the target image to generate an effect video.

For example, in this embodiment, within the context of a video editing application scenario, an interactive interface of a target application includes a video editing interface. An image material track and an image-to-video control are provided within the video editing interface. Navigation to the template page is triggered in response to the first operation on the image-to-video control. A plurality of action templates are displayed within the template page. Next, the target action template is determined in response to the first trigger operation on any action template within the template page. This process is an action template selection process. Then, the image-to-video model is invoked in response to the second trigger operation on the generation control, to process the target action template and the target image to generate the effect video. The generation control is a trigger control for invoking the image-to-video model. The image-to-video model is a video generation model based on a neural network model, and can generate a video based on continuation of a static image, for which specific implementation principles are not described in detail. The image-to-video model may be deployed on a terminal device or in a cloud. When invoked, the image-to-video model performs continuation with the target image as a first frame based on a target interactive behavior represented by the target action template, to generate subsequent image frames of the target image, thereby forming the effect video. The solution provided in the steps of this embodiment is a process of directly selecting and applying the action template provided within the template page, to invoke the image-to-video model to generate a continuation video corresponding to the target image, i.e., the effect video.

Further, in another possible implementation, the terminal device may generate the effect video in another way in response to a third trigger operation of a user. Specifically, an editing control is configured within the template page, and the second operation further includes the third trigger operation. This embodiment further includes the following steps.
Step S205: Display an object configuration page in response to the third trigger operation on the editing control, where a loading slot is configured within the object configuration page, the loading slot being configured to load an uploaded image.
Step S206: Obtain at least one uploaded image in response to a loading operation on the loading slot, where the uploaded image is used to present at least one external visual object.
Step S207: Invoke, in response to a second trigger operation on a generation control, an image-to-video model to process the target action template, the uploaded image, and the target image to generate an effect video, where the effect video is used to present a process in which the at least two target visual objects and the external visual object perform the target interactive behavior represented by the target action template.

For example, in another possible implementation, after the target action template is selected, the editing control is configured within the template page, and the object configuration page is displayed in response to the third trigger operation on the editing control. At least one loading slot for loading an uploaded image is provided within the object configuration page. By performing the loading operation on the loading slot, the user can specify and load an uploaded image. Then, the effect video is generated by combining the uploaded image and the original target image. Since the uploaded image includes the additional external visual object, the generated effect video also includes the corresponding external visual object, and the target interactive behavior between the external visual object and the target visual objects, further improving the flexibility in effect video generation.

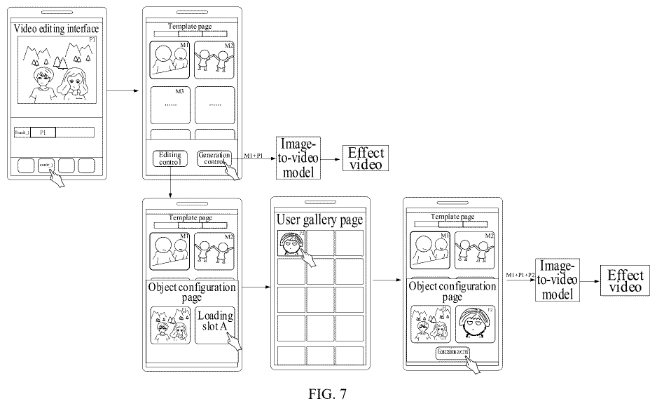

FIG. 7 is a schematic diagram of a process of generating an effect video according to an embodiment of the present disclosure. The above-mentioned process will be described in more detail below with reference to FIG. 7. As shown in FIG. 7, for example, first, after the template page is displayed and a target action template M1 is selected through the first trigger operation, a possible implementation is: invoking, in response to the second trigger operation on the generation control within the template page, the image-to-video model to process the target action template M1 and a target image P1 to generate the effect video. Another possible implementation is: displaying the object configuration page in response to the third trigger operation on the editing control, where a previously obtained target image P1 and a loading slot A are displayed within the object configuration page; next, displaying a user gallery page in response to a tap-and-select operation on the loading slot A, and then loading the image P2 into the loading slot A, in response to a selection operation on an image P2 within the gallery page, where the image P2 is an uploaded image; and then, invoking, in response to the second trigger operation on the generation control provided within the object configuration page, the image-to-video model to process the target action template M1, the image P2, and the target image P1 to generate the effect video. It should be noted that for the two implementations for generating the effect video, during a single effect video generation process, either implementation may be used, or the two implementations may be used sequentially. For example, the process of generating the effect video in response to the second trigger operation on the generation control within the template page is first performed to generate a preview video of the effect video, and then the user performs the third trigger operation to perform the process of generating the effect video in response to the third trigger operation on the editing control within the template page, so as to generate another preview video of the effect video. The final effect video is generated after the user further confirms video effects.

Further, before step S205 and after step S201, the method further includes the following step.
Step S201A: Determine a target quantity of loading slots within the object configuration page.

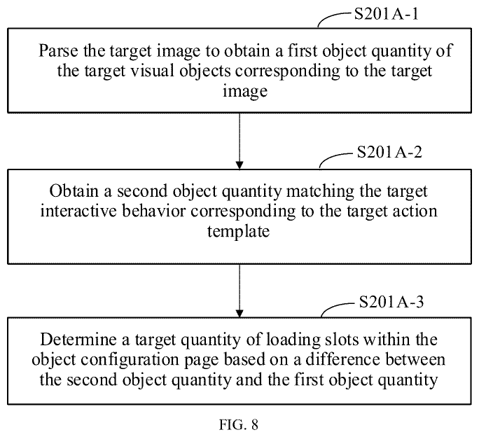

For example, the loading slot is a functional interface for loading an uploaded image, thereby implementing adding of a visual object in the uploaded image to the effect video. In a possible implementation, the loading slot within the object configuration page may be configured manually, that is, the user may freely add a loading slot (within a certain range) as needed. For example, 10 loading slots are added, each loaded with a single portrait photo, such that a “video of hugging” of 11 persons (including one target visual object) can be generated. However, in practical applications of the solution described above, if the quantity of photographed objects involved in generation of the effect video is excessively large or small, the video quality of the finally generated effect video may be affected. Therefore, in another implementation provided in this embodiment, the target quantity of loading slots within the object configuration page may be determined based on content of the target image and the target action template. For example, as shown in FIG. 8, a specific implementation of step S201A includes the following steps.
Step S201A-1: Parse the target image to obtain a first object quantity of the target visual objects corresponding to the target image.
Step S201A-2: Obtain a second object quantity matching the target interactive behavior corresponding to the target action template.
Step S201A-3: Determine the target quantity of loading slots within the object configuration page based on a difference between the second object quantity and the first object quantity.

For example, the first object quantity of the target visual objects corresponding to the target image is first obtained by parsing the target image, for example, the first object quantity is 2, that is, the target image includes two persons. Next, the second object quantity matching the target interactive behavior corresponding to the target action template is obtained. The second object quantity may be an attribute parameter stored in the target action template, and may be obtained directly. The target interactive behavior represented by the target action template is, for example, “four-person hugging”, that is, the second object quantity is 4. The loading slot is configured based on the difference between the second object quantity and the first object quantity. For example, there are two loading slots. Then, the user may load, by using the above-mentioned two loading slots, two uploaded images (e.g., single-person photos) each containing only one visual object for video synthesis. This ensures that the generated effect video quantitatively matches the interactive behavior represented by the target action template, thereby reducing the difficulty of generating the effect video and improving the quality of the generated effect video.

Further, in a possible implementation, the second operation includes a fourth trigger operation, and the target action template is marked with at least two selectable visual objects. After step S203, the method further includes the following steps.
Step S208: Display the selectable visual objects in the target action template.
Step S209: Create, in response to the fourth trigger operation on the selectable visual objects, mapping information between the selectable visual objects and the target visual objects presented in the target image.

For example, since the target interactive behavior represented by the target action template involves two or more visual objects, there is a positional and angular mapping relationship between the visual object involved in the target action template and the target visual object in the target image. For example, when the target interactive behavior represented by the target action template is two-person hugging in a horizontal direction, while the two target visual objects presented in the target image stand in a longitudinal direction, it is necessary to determine how to identify a “hug position” corresponding to each target visual object. In a possible implementation, positions of the above-mentioned target visual objects may be determined randomly based on capabilities provided by the model. In another possible implementation, the mapping information may be first created to indicate the positional mapping relationship between the target visual objects in the target image and the visual objects in the target action template, thereby implementing control over positions of the target visual objects in the generated effect video.

Specifically, in this embodiment, the mapping relationship, i.e., the mapping information, between the selectable visual objects in the target action template and the target visual objects presented in the target image may be created by displaying the selectable visual objects in the target action template and in combination with the fourth trigger operation performed by the user on the selectable visual objects. Accordingly, a specific implementation of step S204 includes the following step.
Step S204A: Invoke, in response to the second trigger operation on the generation control, the image-to-video model to process the target action template, the target image, and the mapping information to generate the effect video, where the effect video is used to display a process in which the target visual objects perform the target interactive behavior of the corresponding selectable visual objects in the target action template.

For example, in this embodiment, on the basis of invoking the image-to-video model to process the target action template and the target image to generate the effect video as described in the previous embodiments, the mapping information is further combined. The mapping information is input into the invoked image-to-video model as a prompt, to control the positional relationship between the target visual objects in the target image and the visual objects in the target action template during effect video generation, thereby implementing more precise control over the video content.

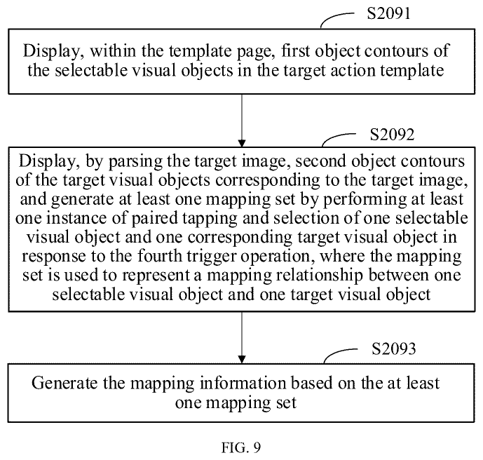

Further, as shown in FIG. 9, a specific implementation of step S209 includes the following steps.
Step S2091: Display, within the template page, first object contours of the selectable visual objects in the target action template.
Step S2092: Display, by parsing the target image, second object contours of the target visual objects corresponding to the target image, and generate at least one mapping set by performing at least one instance of paired tapping and selection of one selectable visual object and one corresponding target visual object in response to the fourth trigger operation, where the mapping set is used to represent a mapping relationship between one selectable visual object and one target visual object.
Step S2093: Generate the mapping information based on the at least one mapping set.

For example, the target action template includes contour information representing object contours of the visual objects. The first object contours of the selectable visual objects in the target action template may be displayed based on the contour information. Then, the terminal device displays, by parsing the target image, the second object contours of the target visual objects corresponding to the target image. When the uploaded image is selected, the second object contours of the external visual objects corresponding to the uploaded image are further displayed. Then, the user identifies the selectable visual objects and the target visual objects based on the first object contours and the second object contours, and maps each selectable visual object to a corresponding target visual object through the fourth trigger operation, thereby establishing a mapping between the selectable visual objects in the action template and the target visual objects in the target image. In the case of excessive target visual objects in the target image, this step further provides screening and filtering functions for the target visual objects, thereby further improving the accuracy and flexibility of control over the video content.

FIG. 10 is a schematic diagram of a process of generating mapping information according to an embodiment of the present disclosure. The above-mentioned process will be further described below with reference to FIG. 10. As shown in FIG. 10, a pairing window is displayed on the template page. The target action template M1 is displayed at one side of the pairing window, and the target image P1 is displayed at the other side of the pairing window. If an uploaded image is selected, the uploaded image may be further displayed at the other side. By parsing the target action template M1 and the target image P1, the first object contours of the selectable visual objects are displayed within the target action template M1, and the second object contours of the target visual objects (external visual object) are displayed within the target image P1 (uploaded image). Next, the user performs the fourth trigger operation to establish the mapping between the selectable visual objects and the target visual objects, to generate at least one mapping set. For example, a selectable visual object m1 is mapped to a target visual object u2, to form a mapping set T1; and a selectable visual object m2 is mapped to a target visual object u1, to form a mapping set T2. The mapping information is finally generated based on a collection of these mapping sets. Then, the positional relationship between the target visual objects in the target image and the visual objects in the target action template is controlled based on the mapping information, thereby implementing more precise control over the video content.

In this embodiment, the implementations of steps S201 and S202 are the same as the implementations of steps S101 and S102 in the embodiment shown in FIG. 2 of the present disclosure, and details are not repeated herein.

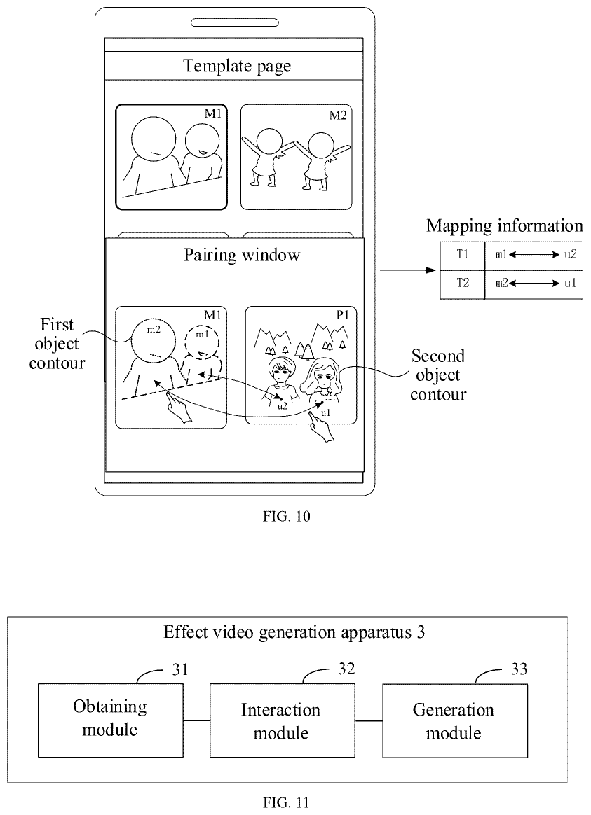

Corresponding to the effect video generation method according to the above-mentioned embodiments, FIG. 11 is a structural block diagram of an effect video generation apparatus according to an embodiment of the present disclosure. The method described in the above-mentioned embodiments may be performed by the effect video generation apparatus. The apparatus may be implemented by software and/or hardware and may be integrated into an electronic device with a certain data processing function. The electronic device may include, but is not limited to, a mobile terminal with a big data processing capability, and a fixed terminal with a big data processing capability such as a desktop computer and a supercomputer.

For ease of illustration, only parts related to this embodiment of the present disclosure are shown. Referring to FIG. 11, the effect video generation apparatus 3 includes:
an obtaining module 31 configured to obtain a target image, where the target image is used to present at least two target visual objects;
an interaction module 32 configured to display at least one action template in response to a first operation, where the action template is configured to represent an interactive behavior between two or more visual objects; and determine a target action template in response to a second operation; and
a generation module 33 configured to generate an effect video based on the target action template and the target image, where the effect video is used to present a process in which the at least two target visual objects perform a target interactive behavior represented by the target action template.

According to one or more embodiments of the present disclosure, the obtaining module 31 is specifically configured to: display a video editing interface, where an image material track and an image-to-video control are configured within the video editing interface, at least one image material being configured within the image material track; and determine an image material within a target image material track in a selected state as the target image, or determine a target image material in a selected state as the target image. The interaction module 32 is specifically configured to: display a template page in response to the first operation on the image-to-video control, where the template page is configured to display the at least one action template.

According to one or more embodiments of the present disclosure, in displaying the template page in response to the first operation on the image-to-video control, the interaction module 32 is specifically configured to: parse a target object quantity of the target visual objects in the target image; determine, in response to the first operation on the image-to-video control, an alternative action template matching the target object quantity, where the alternative action template is configured to represent an interactive behavior between visual objects of the target object quantity; and generate and display the template page based on the alternative action template.

According to one or more embodiments of the present disclosure, the target image includes at least a first image and a second image, where the first image and the second image each are used to present at least one target visual object. In parsing the target object quantity of the target visual objects in the target image, the interaction module 32 is specifically configured to: parse object quantities of target visual objects in the first image and the second image separately, and calculate a sum to determine the target object quantity.

According to one or more embodiments of the present disclosure, the action template is displayed within a template page, a generation control being configured within the template page, and the second operation includes a first trigger operation and a second trigger operation. In determining the target action template in response to the second operation, the interaction module 32 is specifically configured to determine the target action template in response to the first trigger operation on any action template within the template page. In generating the effect video based on the target action template and the target image, the generation module 33 is specifically configured to invoke, in response to the second trigger operation on the generation control, an image-to-video model to process the target action template and the target image to generate the effect video.

According to one or more embodiments of the present disclosure, an editing control is configured within the template page, and the second operation further includes a third trigger operation. The interaction module 32 is further configured to: display an object configuration page in response to the third trigger operation on the editing control, where a loading slot is configured within the object configuration page, the loading slot being configured to load an uploaded image; and obtain at least one uploaded image in response to a loading operation on the loading slot, where the uploaded image is used to present at least one external visual object. The generation module 33 is further configured to invoke, in response to the second trigger operation on the generation control, the image-to-video model to process the target action template, the uploaded image, and the target image to generate the effect video, where the effect video is used to present a process in which the at least two target visual objects and the external visual object perform the target interactive behavior represented by the target action template.

According to one or more embodiments of the present disclosure, before displaying the object configuration page, the interaction module 32 is further configured to: parse the target image to obtain a first object quantity of the target visual objects corresponding to the target image; obtain a second object quantity matching the target interactive behavior corresponding to the target action template; and determine a target quantity of loading slots within the object configuration page based on a difference between the second object quantity and the first object quantity.

According to one or more embodiments of the present disclosure, the second operation includes a fourth trigger operation, and the target action template is marked with at least two selectable visual objects. After determining the target action template in response to the first trigger operation on any action template within the template page, the interaction module 32 is further configured to: display the selectable visual objects in the target action template; and create, in response to the fourth trigger operation on the selectable visual objects, mapping information between the selectable visual objects and the target visual objects presented in the target image. In invoking, in response to the second trigger operation on the generation control, the image-to-video model to process the target action template and the target image to generate the effect video, the generation module 33 is specifically configured to invoke, in response to the second trigger operation on the generation control, the image-to-video model to process the target action template, the target image, and the mapping information to generate the effect video, where the effect video is used to display a process in which the target visual objects perform the target interactive behavior of the corresponding selectable visual objects in the target action template.

According to one or more embodiments of the present disclosure, in creating, in response to the fourth trigger operation on the selectable visual objects, the mapping information between the selectable visual objects and the target visual objects presented in the target image, the generation module 33 is specifically configured to: display, within the template page, first object contours of the selectable visual objects in the target action template; display, by parsing the target image, second object contours of the target visual objects corresponding to the target image, and generate at least one mapping set by performing at least one instance of paired tapping and selection of one selectable visual object and one corresponding target visual object in response to the fourth trigger operation, where the mapping set is used to represent a mapping relationship between one selectable visual object and one target visual object; and generate the mapping information based on the at least one mapping set.

The obtaining module 31, the interaction module 32, and the generation module 33 are connected in sequence. The effect video generation apparatus 3 provided in this embodiment may perform the technical solution of the above-mentioned method embodiments. The implementation principles and technical effects thereof are similar, which are not repeated in this embodiment.

FIG. 12 is a schematic structural diagram of an electronic device according to an embodiment of the present disclosure. As shown in FIG. 12, an electronic device 4 includes:
a processor 41 and a memory 42 communicatively connected to the processor 41.

The memory 42 has computer-executable instructions stored therein.

The processor 41 executes the computer-executable instructions stored in the memory 42 to implement the effect video generation method according to the embodiments shown in FIG. 2 to FIG. 10.

Optionally, the processor 41 is connected to the memory 42 through a bus 43.

The related illustration may be understood with reference to related descriptions and effects that correspond to the steps in the embodiments corresponding to FIG. 2 to FIG. 10. Details are not repeated herein.

An embodiment of the present disclosure provides a computer-readable storage medium, having computer-executable instructions stored therein that, when executed by a processor, cause the effect video generation method according to any one of the embodiments corresponding to FIG. 2 to FIG. 10 of the present disclosure to be implemented.

An embodiment of the present disclosure provides a computer program product including a computer program. When the computer program is executed by a processor, the effect video generation method according to any one of the embodiments corresponding to FIG. 2 to FIG. 10 of the present disclosure is implemented.

In order to implement the above-mentioned embodiments, an embodiment of the present disclosure further provides an electronic device.

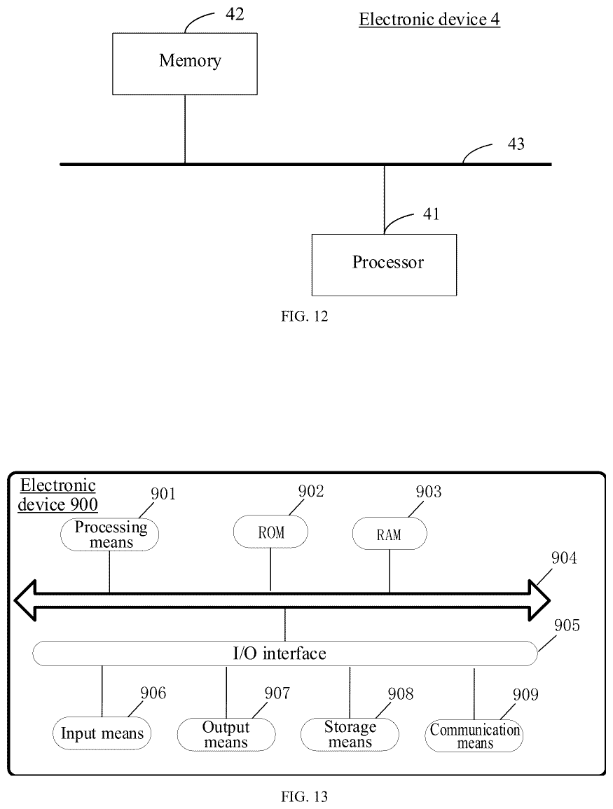

Reference is made to FIG. 13, which is a schematic structural diagram of an electronic device 900 suitable for implementing an embodiment of the present disclosure. The electronic device 900 may be a terminal device or a server. The terminal device may include, but is not limited to, a mobile terminal such as a mobile phone, a notebook computer, a digital broadcast receiver, a personal digital assistant (PDA), a tablet computer, a portable media player (PMP), and a vehicle-mounted terminal (such as a vehicle navigation terminal), and a fixed terminal such as a digital TV and a desktop computer. The electronic device shown in FIG. 13 is merely an example, and shall not impose any limitation on the function and scope of use of the embodiments of the present disclosure.

As shown in FIG. 13, the electronic device 900 may include a processing means (for example, a central processing unit or a graphics processing unit) 901 that may perform a variety of appropriate actions and processing based on a program stored in a read-only memory (ROM) 902 or a program loaded from a storage means 908 into a random-access memory (RAM) 903. The RAM 903 further stores various programs and data required for the operation of the electronic device 900. The processing means 901, the ROM 902, and the RAM 903 are connected to one another through a bus 904. An input/output (I/O) interface 905 is also connected to the bus 904.

Generally, the following means may be connected to the I/O interface 905: an input means 906 including, for example, a touchscreen, a touchpad, a keyboard, a mouse, a camera, a microphone, an accelerometer, and a gyroscope; an output means 907 including, for example, a liquid crystal display (LCD), a speaker, and a vibrator; the storage means 908 including, for example, a magnetic tape and a hard disk drive; and a communication means 909. The communication means 909 may allow the electronic device 900 to perform wireless or wired communication with other devices to exchange data. Although FIG. 13 shows the electronic device 900 having various apparatuses, it should be understood that it is not required to implement or have all of the shown apparatuses. It may be an alternative to implement or have more or fewer apparatuses.

In particular, according to an embodiment of the present disclosure, the process described above with reference to the flowchart may be implemented as a computer software program. For example, this embodiment of the present disclosure includes a computer program product, which includes a computer program carried on a computer-readable medium, where the computer program includes program code for performing the method shown in the flowchart. In such an embodiment, the computer program may be downloaded and installed from a network through the communication means 909, installed from the storage means 908, or installed from the ROM 902. When the computer program is executed by the processing means 901, the above-mentioned functions defined in the method according to the embodiments of the present disclosure are performed.

It should be noted that the above-mentioned computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. More specific examples of the computer-readable storage medium may include, but are not limited to: an electrical connection having one or more wires, a portable computer magnetic disk, a hard disk drive, a random-access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may alternatively be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), and the like, or any suitable combination thereof.

The above-mentioned computer-readable medium may be included in the above-mentioned electronic device. Alternatively, the computer-readable medium may exist independently, without being assembled into the electronic device.

The above-mentioned computer-readable medium carries one or more programs that, when executed by the electronic device, cause the electronic device to perform the method shown in the above-mentioned embodiments.

The computer program code for performing the operations in the present disclosure may be written in one or more programming languages or a combination thereof, where the programming languages include an object-oriented programming language, such as Java, Smalltalk, or C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user via any kind of network, including a local area network (LAN) or a wide area network (WAN), or may be connected to an external computer (for example, connected via the Internet with the aid of an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units or modules described in the embodiments of the present disclosure may be implemented by software, or may be implemented by hardware. The name of the unit or module does not constitute a limitation on the unit itself under certain circumstances.

The functions described herein above may be performed at least partially by one or more hardware logic components. For example, without limitation, example types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk drive, a random-access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

In a first aspect, according to one or more embodiments of the present disclosure, an effect video generation method is provided. The method includes:
obtaining a target image, where the target image is used to present at least two target visual objects; displaying at least one action template in response to a first operation, where the action template is configured to represent an interactive behavior between two or more visual objects; and determining a target action template in response to a second operation, and generating an effect video based on the target action template and the target image, where the effect video is used to present a process in which the at least two target visual objects perform a target interactive behavior represented by the target action template.

According to one or more embodiments of the present disclosure, obtaining the target image includes: displaying a video editing interface, where an image material track and an image-to-video control are configured within the video editing interface, at least one image material being configured within the image material track; and determining an image material within a target image material track in a selected state as the target image, or determining a target image material in a selected state as the target image. Displaying the at least one action template in response to the first operation includes: displaying a template page in response to the first operation on the image-to-video control, where the template page is configured to display the at least one action template.

According to one or more embodiments of the present disclosure, displaying the template page in response to the first operation on the image-to-video control includes: parsing a target object quantity of the target visual objects in the target image; determining, in response to the first operation on the image-to-video control, an alternative action template matching the target object quantity, where the alternative action template is configured to represent an interactive behavior between visual objects of the target object quantity; and generating and displaying the template page based on the alternative action template.

According to one or more embodiments of the present disclosure, the target image includes at least a first image and a second image, where the first image and the second image each are used to present at least one target visual object. Parsing the target object quantity of the target visual objects in the target image includes: parsing object quantities of target visual objects in the first image and the second image separately, and calculate a sum to determine the target object quantity.

According to one or more embodiments of the present disclosure, the action template is displayed within a template page, a generation control being configured within the template page, and the second operation includes a first trigger operation and a second trigger operation. Determining the target action template in response to the second operation, and generating the effect video based on the target action template and the target image includes: determining the target action template in response to the first trigger operation on any action template within the template page; and invoking, in response to the second trigger operation on the generation control, an image-to-video model to process the target action template and the target image to generate the effect video.

According to one or more embodiments of the present disclosure, an editing control is configured within the template page, and the second operation further includes a third trigger operation. The method further includes: displaying an object configuration page in response to the third trigger operation on the editing control, where a loading slot is configured within the object configuration page, the loading slot being configured to load an uploaded image; obtaining at least one uploaded image in response to a loading operation on the loading slot, where the uploaded image is used to present at least one external visual object; and invoking, in response to the second trigger operation on the generation control, the image-to-video model to process the target action template, the uploaded image, and the target image to generate the effect video, where the effect video is used to present a process in which the at least two target visual objects and the external visual object perform the target interactive behavior represented by the target action template.

According to one or more embodiments of the present disclosure, before displaying the object configuration page, the method further includes: parsing the target image to obtain a first object quantity of the target visual objects corresponding to the target image; obtaining a second object quantity matching the target interactive behavior corresponding to the target action template; and determining a target quantity of loading slots within the object configuration page based on a difference between the second object quantity and the first object quantity.

According to one or more embodiments of the present disclosure, the second operation includes a fourth trigger operation, and the target action template is marked with at least two selectable visual objects. After determining the target action template in response to the first trigger operation on any action template within the template page, the method further includes: displaying the selectable visual objects in the target action template; and creating, in response to the fourth trigger operation on the selectable visual objects, mapping information between the selectable visual objects and the target visual objects presented in the target image. Invoking, in response to the second trigger operation on the generation control, the image-to-video model to process the target action template and the target image to generate the effect video includes: invoking, in response to the second trigger operation on the generation control, the image-to-video model to process the target action template, the target image, and the mapping information to generate the effect video, where the effect video is used to present a process in which the target visual objects perform the target interactive behavior of the corresponding selectable visual objects in the target action template.

According to one or more embodiments of the present disclosure, creating, in response to the fourth trigger operation on the selectable visual objects, the mapping information between the selectable visual objects and the target visual objects presented in the target image includes: displaying, within the template page, first object contours of the selectable visual objects in the target action template; displaying, by parsing the target image, second object contours of the target visual objects corresponding to the target image, and generating at least one mapping set by performing at least one instance of paired tapping and selection of one selectable visual object and one corresponding target visual object in response to the fourth trigger operation, where the mapping set is used to represent a mapping relationship between one selectable visual object and one target visual object; and generating the mapping information based on the at least one mapping set.

In a second aspect, according to one or more embodiments of the present disclosure, an effect video generation apparatus is provided. The apparatus includes:
an obtaining module configured to obtain a target image, where the target image is used to present at least two target visual objects;
an interaction module configured to display at least one action template in response to a first operation, where the action template is configured to represent an interactive behavior between two or more visual objects; and determine a target action template in response to a second operation; and
a generation module configured to generate an effect video based on the target action template and the target image, where the effect video is used to present a process in which the at least two target visual objects perform a target interactive behavior represented by the target action template.

According to one or more embodiments of the present disclosure, the obtaining module is specifically configured to: display a video editing interface, where an image material track and an image-to-video control are configured within the video editing interface, at least one image material being configured within the image material track; and determine an image material within a target image material track in a selected state as the target image, or determine a target image material in a selected state as the target image. The interaction module is specifically configured to display a template page in response to the first operation on the image-to-video control, where the template page is configured to display the at least one action template.

According to one or more embodiments of the present disclosure, in displaying the template page in response to the first operation on the image-to-video control, the interaction module is specifically configured to: parse a target object quantity of the target visual objects in the target image; determine, in response to the first operation on the image-to-video control, an alternative action template matching the target object quantity, where the alternative action template is configured to represent an interactive behavior between visual objects of the target object quantity; and generate and display the template page based on the alternative action template.

According to one or more embodiments of the present disclosure, the target image includes at least a first image and a second image, where the first image and the second image are separately used to present at least one target visual object. In parsing the target object quantity of the target visual objects in the target image, the interaction module is specifically configured to: parse object quantities of target visual objects in the first image and the second image separately, and calculate a sum to determine the target object quantity.

According to one or more embodiments of the present disclosure, the action template is displayed within a template page, a generation control being configured within the template page, and the second operation includes a first trigger operation and a second trigger operation. In determining the target action template in response to the second operation, the interaction module is specifically configured to determine the target action template in response to the first trigger operation on any action template within the template page. In generating the effect video based on the target action template and the target image, the generation module is specifically configured to invoke, in response to the second trigger operation on the generation control, an image-to-video model to process the target action template and the target image to generate the effect video.

According to one or more embodiments of the present disclosure, an editing control is configured within the template page, and the second operation further includes a third trigger operation. The interaction module is further configured to: display an object configuration page in response to the third trigger operation on the editing control, where a loading slot is configured within the object configuration page, the loading slot being configured to load an uploaded image; and obtain at least one uploaded image in response to a loading operation on the loading slot, where the uploaded image is used to present at least one external visual object. The generation module is further configured to invoke, in response to the second trigger operation on the generation control, the image-to-video model to process the target action template, the uploaded image, and the target image to generate the effect video, where the effect video is used to present a process in which the at least two target visual objects and the external visual object perform the target interactive behavior represented by the target action template.

According to one or more embodiments of the present disclosure, before displaying the object configuration page, the interaction module is further configured to: parse the target image to obtain a first object quantity of the target visual objects corresponding to the target image; obtain a second object quantity matching the target interactive behavior corresponding to the target action template; and determine a target quantity of loading slots within the object configuration page based on a difference between the second object quantity and the first object quantity.

According to one or more embodiments of the present disclosure, the second operation includes a fourth trigger operation, and the target action template is marked with at least two selectable visual objects. After determining the target action template in response to the first trigger operation on any action template within the template page, the interaction module is further configured to: display the selectable visual objects in the target action template; and create, in response to the fourth trigger operation on the selectable visual objects, mapping information between the selectable visual objects and the target visual objects presented in the target image. In invoking, in response to the second trigger operation on the generation control, the image-to-video model to process the target action template and the target image to generate the effect video, the generation module is specifically configured to invoke, in response to the second trigger operation on the generation control, the image-to-video model to process the target action template, the target image, and the mapping information to generate the effect video, where the effect video is used to present a process in which the target visual objects perform the target interactive behavior of the corresponding selectable visual objects in the target action template.

According to one or more embodiments of the present disclosure, in creating, in response to the fourth trigger operation on the selectable visual objects, the mapping information between the selectable visual objects and the target visual objects presented in the target image, the generation module is specifically configured to: display, within the template page, first object contours of the selectable visual objects in the target action template; display, by parsing the target image, second object contours of the target visual objects corresponding to the target image, and generate at least one mapping set by performing at least one instance of paired tapping and selection of one selectable visual object and one corresponding target visual object in response to the fourth trigger operation, where the mapping set is used to represent a mapping relationship between one selectable visual object and one target visual object; and generate the mapping information based on the at least one mapping set.

In a third aspect, according to one or more embodiments of the present disclosure, an electronic device is provided. The electronic device includes: at least one processor and a memory, where
the memory has computer-executable instructions stored therein; and
the at least one processor executes the computer-executable instructions stored in the memory, to cause the at least one processor to perform the effect video generation method according to the first aspect and various possible designs of the first aspect.

In a fourth aspect, according to one or more embodiments of the present disclosure, a computer-readable storage medium is provided. The computer-readable storage medium has computer-executable instructions stored therein that, when executed by a processor, cause the effect video generation method according to the first aspect and various possible designs of the first aspect to be implemented.

In a fifth aspect, according to one or more embodiments of the present disclosure, a computer program product including a computer program is provided. When the computer program is executed by a processor, the effect video generation method according to the first aspect and various possible designs of the first aspect is implemented.

The above-mentioned descriptions are merely preferred embodiments of the present disclosure and explanations of the applied technical principles. Those skilled in the art should understand that the scope of disclosure involved in the present disclosure is not limited to the technical solutions formed by specific combinations of the above-mentioned technical features, and shall also cover other technical solutions formed by any combination of the above-mentioned technical features or equivalent features thereof without departing from the above-mentioned disclosed concept. For example, a technical solution formed by a replacement of the above-mentioned features with technical features with similar functions disclosed in the present disclosure (but not limited thereto) also falls within the scope of the present disclosure.

In addition, although the various operations are depicted in a specific order, it should not be construed as requiring these operations to be performed in the specific order shown or in a sequential order. Under certain circumstances, multitasking and parallel processing may be advantageous. Similarly, although several specific implementation details are included in the above-mentioned discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable sub-combination.

Although the subject matter has been described in a language specific to structural features and/or logical actions of the method, it should be understood that the subject matter defined in the appended claims is not necessarily limited to the specific features or actions described above. In contrast, the specific features and actions described above are merely example forms of implementing the claims.

What is claimed is:

1. An effect video generation method, comprising:
obtaining a target image, wherein the target image is used to present at least two target visual objects;
displaying at least one action template in response to a first operation, wherein the action template is configured to represent an interactive behavior between two or more visual objects; and
determining a target action template in response to a second operation, and generating an effect video based on the target action template and the target image, wherein the effect video is used to present a process in which the at least two target visual objects perform a target interactive behavior represented by the target action template.

2. The method according to claim 1, wherein obtaining the target image comprises:
displaying a video editing interface, wherein an image material track and an image-to-video control are configured within the video editing interface, at least one image material being configured within the image material track; and
determining an image material within a target image material track in a selected state as the target image, or determining a target image material in a selected state as the target image;
displaying the at least one action template in response to the first operation comprises:
displaying a template page in response to the first operation on the image-to-video control, wherein the template page is configured to display the at least one action template; and
after generating the effect video, the method further comprises: replacing the target image within the image material track with the effect video.

3. The method according to claim 2, wherein displaying the template page in response to the first operation on the image-to-video control comprises:
parsing a target object quantity of the target visual objects in the target image;
determining, in response to the first operation on the image-to-video control, an alternative action template matching the target object quantity, wherein the alternative action template is configured to represent an interactive behavior between visual objects of the target object quantity; and
generating and displaying the template page based on the alternative action template.

4. The method according to claim 3, wherein the target image comprises at least a first image and a second image, wherein the first image and the second image each are used to present at least one target visual object; and
parsing the target object quantity of the target visual objects in the target image comprises:
parsing object quantities of target visual objects in the first image and the second image separately, and calculating a sum to determine the target object quantity.

5. The method according to claim 1, wherein the action template is displayed within a template page, a generation control being configured within the template page, the second operation comprises a first trigger operation and a second trigger operation, and determining the target action template in response to the second operation, and generating the effect video based on the target action template and the target image comprises:
determining the target action template in response to the first trigger operation on any action template within the template page; and
invoking, in response to the second trigger operation on the generation control, an image-to-video model to process the target action template and the target image to generate the effect video.

6. The method according to claim 5, wherein an editing control is configured within the template page, the second operation further comprises a third trigger operation, and the method further comprises:
displaying an object configuration page in response to the third trigger operation on the editing control, wherein a loading slot is configured within the object configuration page, the loading slot being configured to load an uploaded image;
obtaining at least one uploaded image in response to a loading operation on the loading slot, wherein the uploaded image is used to present at least one external visual object; and
invoking, in response to the second trigger operation on the generation control, the image-to-video model to process the target action template, the uploaded image, and the target image to generate the effect video, wherein the effect video is used to present a process in which the at least two target visual objects and the external visual object perform the target interactive behavior represented by the target action template.

7. The method according to claim 6, wherein before displaying the object configuration page, the method further comprises:
parsing the target image to obtain a first object quantity of the target visual objects corresponding to the target image;
obtaining a second object quantity matching the target interactive behavior corresponding to the target action template; and
determining a target quantity of loading slots within the object configuration page based on a difference between the second object quantity and the first object quantity.

8. The method according to claim 5, wherein the second operation comprises a fourth trigger operation, the target action template is marked with at least two selectable visual objects, and after determining the target action template in response to the first trigger operation on any action template within the template page, the method further comprises:
displaying the selectable visual objects in the target action template; and
creating, in response to the fourth trigger operation on the selectable visual objects, mapping information between the selectable visual objects and the target visual objects presented in the target image; and
invoking, in response to the second trigger operation on the generation control, the image-to-video model to process the target action template and the target image to generate the effect video comprises:
invoking, in response to the second trigger operation on the generation control, the image-to-video model to process the target action template, the target image, and the mapping information to generate the effect video, wherein the effect video is used to present a process in which the target visual objects perform the target interactive behavior of the corresponding selectable visual objects in the target action template.

9. The method according to claim 8, wherein creating, in response to the fourth trigger operation on the selectable visual objects, the mapping information between the selectable visual objects and the target visual objects presented in the target image comprises:
displaying, within the template page, first object contours of the selectable visual objects in the target action template;
displaying, by parsing the target image, second object contours of the target visual objects corresponding to the target image, and generating at least one mapping set by performing at least one instance of paired tapping and selection of one selectable visual object and one corresponding target visual object in response to the fourth trigger operation, wherein the mapping set is used to represent a mapping relationship between one selectable visual object and one target visual object; and
generating the mapping information based on the at least one mapping set.

10. An electronic device, comprising: a processor and a memory, wherein
the memory has computer-executable instructions stored therein; and
the processor executes the computer-executable instructions stored in the memory, to cause the processor to perform an effect video generation method comprising:
obtaining a target image, wherein the target image is used to present at least two target visual objects;
displaying at least one action template in response to a first operation, wherein the action template is configured to represent an interactive behavior between two or more visual objects; and
determining a target action template in response to a second operation, and generating an effect video based on the target action template and the target image, wherein the effect video is used to present a process in which the at least two target visual objects perform a target interactive behavior represented by the target action template.

11. A non-transitory computer-readable storage medium, having computer-executable instructions stored therein that, when executed by a processor, cause an effect video generation method to be implemented, the effect video generation method comprising:
obtaining a target image, wherein the target image is used to present at least two target visual objects;
displaying at least one action template in response to a first operation, wherein the action template is configured to represent an interactive behavior between two or more visual objects; and
determining a target action template in response to a second operation, and generating an effect video based on the target action template and the target image, wherein the effect video is used to present a process in which the at least two target visual objects perform a target interactive behavior represented by the target action template.

12. The electronic device according to claim 10, wherein obtaining the target image comprises:
displaying a video editing interface, wherein an image material track and an image-to-video control are configured within the video editing interface, at least one image material being configured within the image material track; and
determining an image material within a target image material track in a selected state as the target image, or determining a target image material in a selected state as the target image;
displaying the at least one action template in response to the first operation comprises:
displaying a template page in response to the first operation on the image-to-video control, wherein the template page is configured to display the at least one action template; and
after generating the effect video, the method further comprises: replacing the target image within the image material track with the effect video.

13. The electronic device according to claim 12, wherein displaying the template page in response to the first operation on the image-to-video control comprises:
parsing a target object quantity of the target visual objects in the target image;
determining, in response to the first operation on the image-to-video control, an alternative action template matching the target object quantity, wherein the alternative action template is configured to represent an interactive behavior between visual objects of the target object quantity; and
generating and displaying the template page based on the alternative action template.

14. The electronic device according to claim 13, wherein the target image comprises at least a first image and a second image, wherein the first image and the second image each are used to present at least one target visual object; and
parsing the target object quantity of the target visual objects in the target image comprises:
parsing object quantities of target visual objects in the first image and the second image separately, and calculating a sum to determine the target object quantity.

15. The electronic device according to claim 10, wherein the action template is displayed within a template page, a generation control being configured within the template page, the second operation comprises a first trigger operation and a second trigger operation, and determining the target action template in response to the second operation, and generating the effect video based on the target action template and the target image comprises:
determining the target action template in response to the first trigger operation on any action template within the template page; and
invoking, in response to the second trigger operation on the generation control, an image-to-video model to process the target action template and the target image to generate the effect video.

16. The electronic device according to claim 15, wherein an editing control is configured within the template page, the second operation further comprises a third trigger operation, and the method further comprises:
displaying an object configuration page in response to the third trigger operation on the editing control, wherein a loading slot is configured within the object configuration page, the loading slot being configured to load an uploaded image;
obtaining at least one uploaded image in response to a loading operation on the loading slot, wherein the uploaded image is used to present at least one external visual object; and
invoking, in response to the second trigger operation on the generation control, the image-to-video model to process the target action template, the uploaded image, and the target image to generate the effect video, wherein the effect video is used to present a process in which the at least two target visual objects and the external visual object perform the target interactive behavior represented by the target action template.

17. The non-transitory computer-readable storage medium according to claim 11, wherein obtaining the target image comprises:
displaying a video editing interface, wherein an image material track and an image-to-video control are configured within the video editing interface, at least one image material being configured within the image material track; and
determining an image material within a target image material track in a selected state as the target image, or determining a target image material in a selected state as the target image;
displaying the at least one action template in response to the first operation comprises:
displaying a template page in response to the first operation on the image-to-video control, wherein the template page is configured to display the at least one action template; and
after generating the effect video, the method further comprises: replacing the target image within the image material track with the effect video.

18. The non-transitory computer-readable storage medium according to claim 17, wherein displaying the template page in response to the first operation on the image-to-video control comprises:
parsing a target object quantity of the target visual objects in the target image;
determining, in response to the first operation on the image-to-video control, an alternative action template matching the target object quantity, wherein the alternative action template is configured to represent an interactive behavior between visual objects of the target object quantity; and
generating and displaying the template page based on the alternative action template.

19. The non-transitory computer-readable storage medium according to claim 18, wherein the target image comprises at least a first image and a second image, wherein the first image and the second image each are used to present at least one target visual object; and
parsing the target object quantity of the target visual objects in the target image comprises:
parsing object quantities of target visual objects in the first image and the second image separately, and calculating a sum to determine the target object quantity.

20. The non-transitory computer-readable storage medium according to claim 11, wherein the action template is displayed within a template page, a generation control being configured within the template page, the second operation comprises a first trigger operation and a second trigger operation, and determining the target action template in response to the second operation, and generating the effect video based on the target action template and the target image comprises:
determining the target action template in response to the first trigger operation on any action template within the template page; and
invoking, in response to the second trigger operation on the generation control, an image-to-video model to process the target action template and the target image to generate the effect video.
